(19) United States
(12) Patent Application Publication
(10) Pub. No.: US 2026/0160989 A1
(43) Pub. Date: Jun. 11, 2026

(54) MAGNIFYING GLASS AND LIGHTING TOOL ASSEMBLY

(71) Applicant: Hong Ann Tool Industries Co., Ltd., Taichung City (TW)

(72) Inventor: Cheng-Wei SU, Taichung City (TW)

(21) Appl. No.: 19/338,829

(22) Filed: Sep. 24, 2025

(30) Foreign Application Priority Data
Dec. 9, 2024 (TW) 113147724

(51) Int. Cl. G02B 25/02; F21S 6/00; F21V 21/06; F21V 21/096; F21V 21/116; F21V 21/30; F21V 21/32; G02B 25/00

(52) U.S. Cl. CPC G02B 25/02; F21S 6/005; F21V 21/06; F21V 21/096; F21V 21/116; F21V 21/30; F21V 21/32; G02B 25/005

(57) ABSTRACT

A magnifying glass and lighting tool assembly includes a support frame having a connection part, an illumination device with a housing and light head detachably connectable to the connection part, and a magnifying glass fitted over the light head and detachably connectable to the housing. The light head is rotatably mounted to the housing. The support frame includes a flexible tube member connected to a magnetic member. The tool assembly enables combined use of the illumination device and magnifying glass, or independent use of either component through detachable connections.

### BACKGROUND OF THE INVENTION

The present invention relates to a tool assembly, and more particularly to a magnifying glass and lighting tool assembly.

Taiwan Patent No. I383174 discloses a lighting apparatus comprising a magnifier assembly and a lamp base. The magnifier assembly includes multiple illumination lights positioned around its lens for lighting purposes. When the magnifier assembly's power block requires recharging, its handle can be inserted into a slot within the lamp base for charging. Furthermore, when combined with the lamp base, the magnifier assembly can function as a task lamp.

However, users are only able to control the activation of the illumination lights; they cannot separate the magnifier from the illumination lights for independent use. This inherent integration restricts the versatility and use cases of the device.

The present invention is therefore intended to obviate or at least alleviate the problems encountered in the prior art.

### SUMMARY OF THE INVENTION

The present invention provides a magnifying glass and lighting tool assembly. The assembly comprises a support frame with a connection part, an illumination device, and a magnifying glass. The illumination device, which includes a housing and a light head, is detachably connected to the connection part. The magnifying glass is fitted over the light head and is also detachably connected to the housing. This structure allows the illumination device and magnifying glass to be used either jointly or separately.

Other objectives, advantages, and new features of the present invention will become apparent from the following detailed description of the invention when considered in conjunction with the accompanying drawings.

### BRIEF DESCRIPTION OF DRAWINGS

FIG. 1 is a perspective view of the magnifying glass and lighting tool assembly according to the present invention.

FIG. 2 is an exploded perspective view of the magnifying glass and lighting tool assembly of FIG. 1.

FIG. 3 is an exploded perspective view of the magnifying glass and lighting tool assembly of FIG. 1 from another angle.

FIG. 4 is a cross-sectional view of the magnifying glass and lighting tool assembly of FIG. 1.

FIG. 5 is a partially enlarged cross-sectional view of the magnifying glass and lighting tool assembly of FIG. 1.

FIG. 6 is a cross-sectional view of the magnifying glass and lighting tool assembly of FIG. 1 from another angle.

FIG. 7 shows the magnifying glass and lighting tool assembly of FIG. 1 in use, with its light head adjusted.

### DETAILED DESCRIPTION OF THE INVENTION

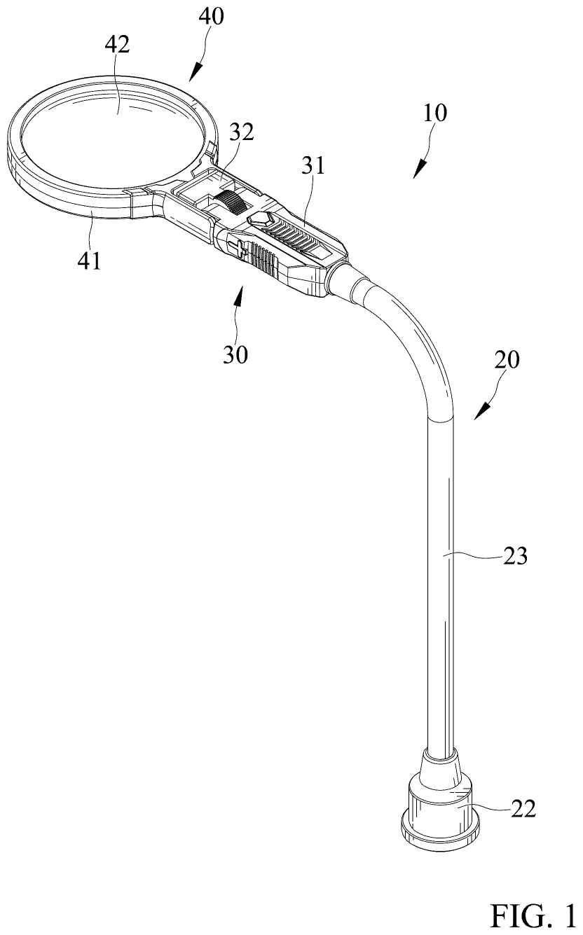

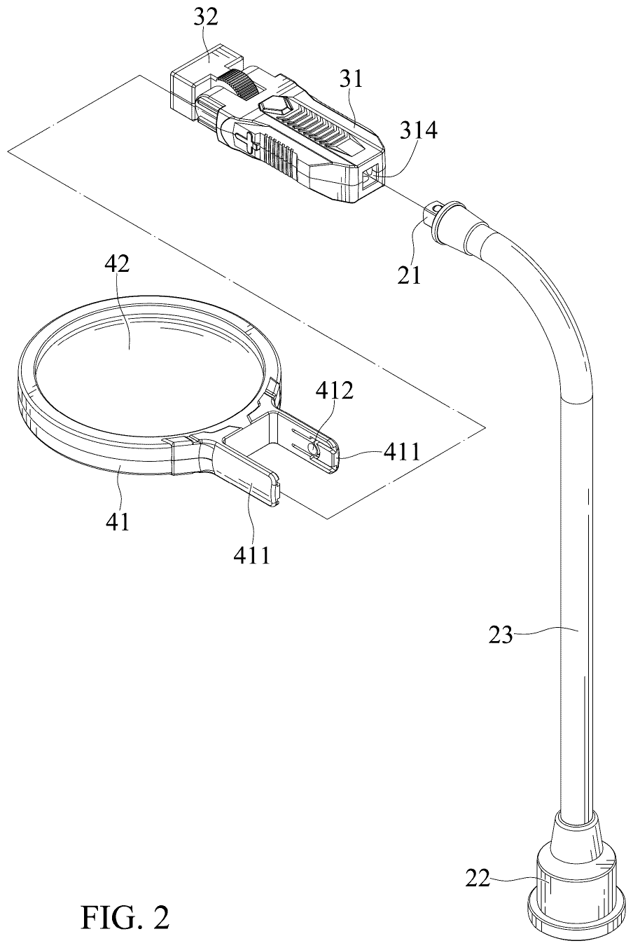

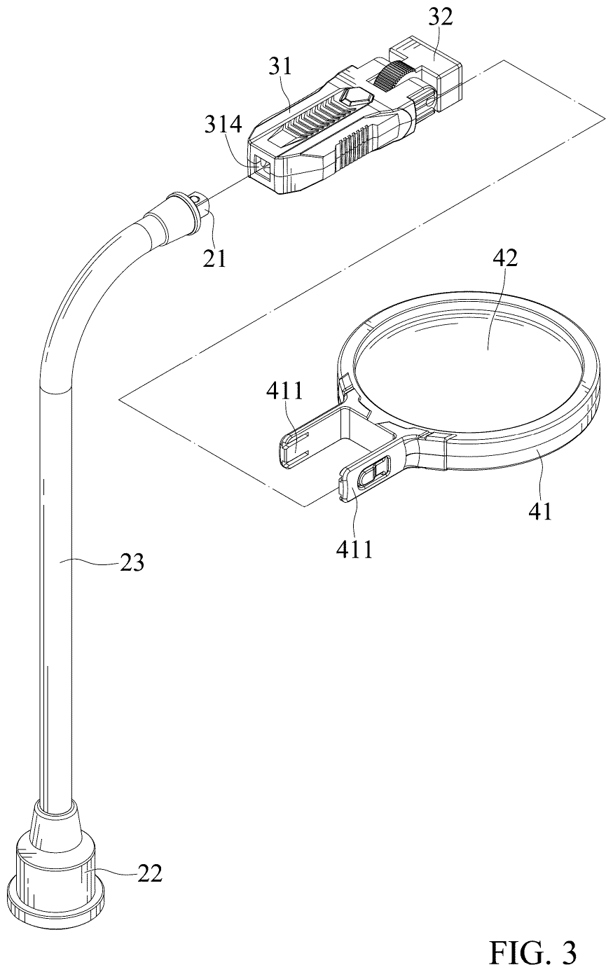

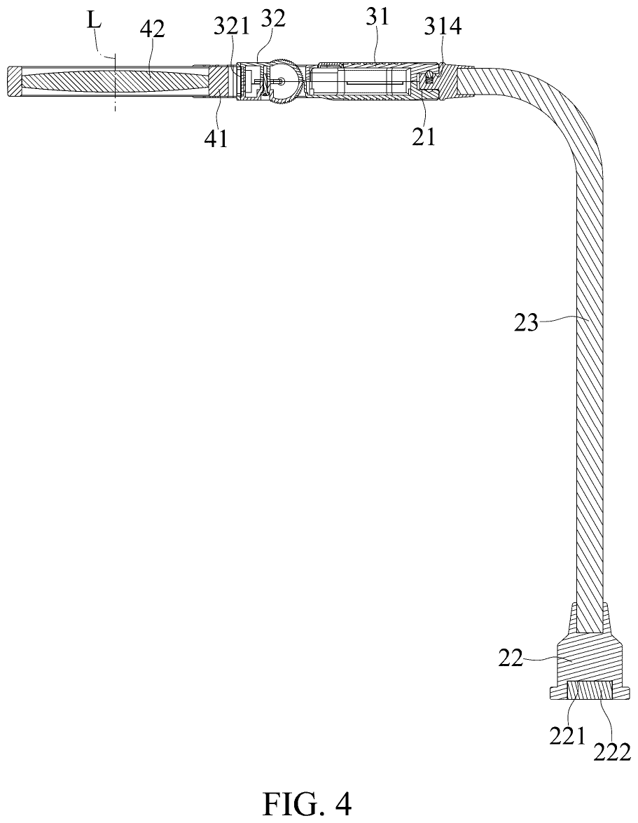

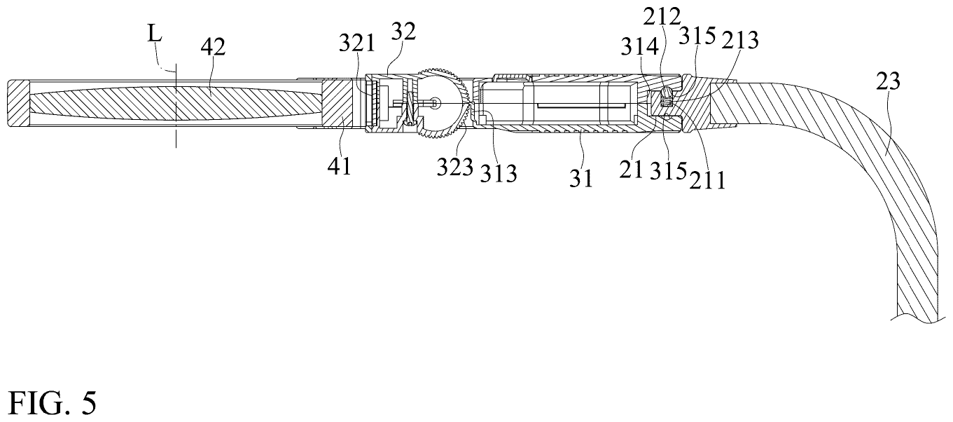

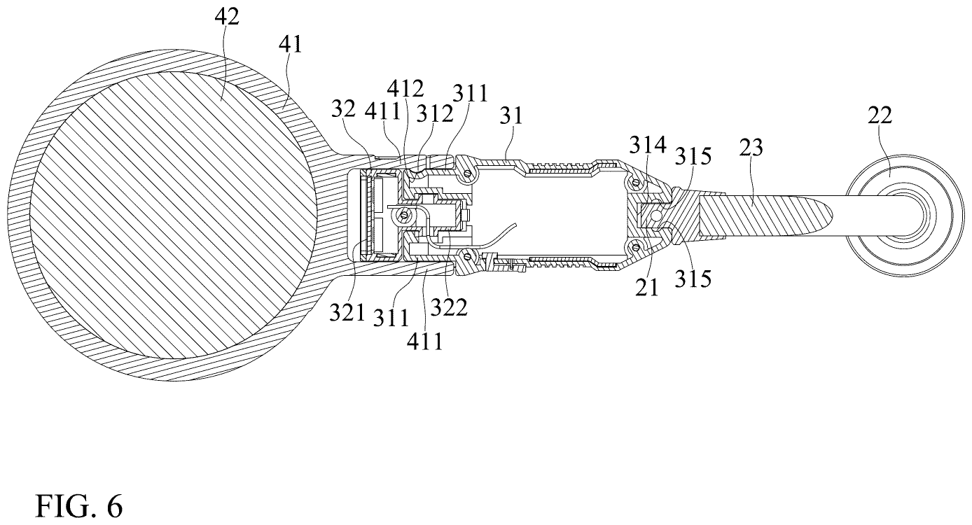

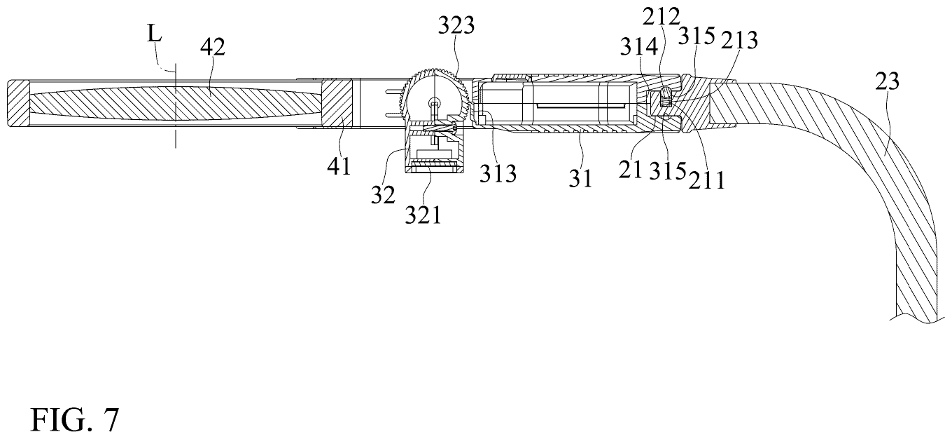

FIGS. 1-7 show a magnifying glass and lighting tool assembly 10 according to the present invention. The magnifying glass and lighting tool assembly 10 comprises a support frame 20, an illumination device 30, and a magnifying glass 40.

The support frame 20 includes a base 22 and a flexible tube member 23. One end of the tube member 23 is connected to the base 22, while the opposite end is provided with a connection part 21.

The base 22 includes a groove 221 at its end opposite the tube member 23. A magnetic member 222 is disposed within the groove 221, allowing the assembly to be securely attached to various ferrous surfaces. The flexible tube member 23 can be bent into any desired shape, enabling versatile positioning of the assembly.

The connection part 21 is configured with a quadrangular shape for mating with the illumination device 30. The connection part 21 further includes a receiving groove 211 on its outer periphery, which houses a locking member 212 and an elastic member 213. The elastic member 213 biases the locking member 212 outward.

The illumination device 30 includes a housing 31 and a light head 32. The housing 31 is provided with a quadrangular insertion hole 314 at one end, which is configured to detachably receive the connection part 21 of the support frame 20. The insertion hole 314 has a plurality of locking grooves 315 on its inner periphery. The locking member 212 of the connection part 21 engages with one of these locking grooves 315 to secure the two components together.

The light head 32 is pivotally mounted to the end of the housing 31 opposite the connection part 21. The housing 31 has two first pivot ears 311, and the light head 32 has a second pivot ear 322 that is pivotally mounted between the two first pivot ears 311. The light head 32 includes a light-emitting portion 321 opposite the housing 31. A toothed portion 323 on the outer periphery of the second pivot ear 322 engages with a corresponding catch tooth 313 on the housing 31. This engagement allows the light head 32 to be held in a fixed rotational position.

The pivotal mounting of the light head 32 allows the light-emitting portion 321 to be rotated relative to the housing 31 to provide either on-axis illumination (directed towards the optical axis L) or off-axis illumination (directed in a direction parallel to the optical axis L).

The magnifying glass 40 is configured to be detachably connected to the end of the housing 31 that holds the light head 32. The magnifying glass 40 includes an outer frame 41 and a lens 42. The lens 42 is mounted within the outer frame 41 and has a virtual optical axis L passing through its center.

The outer frame 41 has two engaging ears 411 that respectively engage with the two first pivot ears 311 of the housing 31. One of the two engaging ears 411 has a protrusion 412 that engages with a recess 312 on one of the first pivot ears 311, ensuring a stable and secure connection.

The magnifying glass 40 is fitted over the light head 32 and can be detachably connected to the end of the housing 31 opposite to the connection part 21.

The magnifying glass 40 includes an outer frame 41 and a lens 42. The outer frame 41 is detachably connected to the housing 31, and the lens 42 is connected to the outer frame 41. The lens 42 has a virtual optical axis L passing through the center of the lens 42. The light head 32 has a light-emitting portion 321 opposite to the housing 31, which is capable of emitting light at the end. The light head 32 is pivotally mounted to the housing 31. When the light head 32 rotates relative to the housing 31, the light-emitting portion 321 faces towards the optical axis L or in a direction parallel to the optical axis L. Therefore, the light head 32 can rotate to provide both on-axis illumination (directly along the optical axis L) and off-axis illumination (parallel to the optical axis L).

In view of the foregoing, the magnifying glass and lighting tool assembly 10 provides a versatile and practical solution through its modular design. The magnifying glass and lighting tool assembly 10 can operate in multiple configurations: the illumination device 30 and magnifying glass 40 can be used together for optimal magnification with lighting, or each component can be used independently according to specific task requirements. The pivotally mounted light head 32 enables the light-emitting portion 321 to direct illumination either towards the optical axis L for direct task lighting or parallel to the optical axis L to minimize glare during magnification work. When using the complete magnifying glass and lighting tool assembly 10, the flexible support frame 20 can be securely attached to various objects through the magnetic member 222, allowing the illumination device 30 and magnifying glass 40 to be positioned and fixed as needed.

Although specific embodiments have been illustrated and described, numerous modifications and variations are still possible without departing from the scope of the invention. The scope of the invention is limited by the accompanying claims.

1. A magnifying glass and lighting tool assembly, comprising: a support frame having a connection part; an illumination device including a housing and a light head, wherein one end of the housing is detachably connectable to the connection part, and the light head is connected to an end of the housing opposite to the connection part; and a magnifying glass fitted over the light head and detachably connectable to the end of the housing opposite to the connection part.

2. The magnifying glass and lighting tool assembly according to claim 1, wherein the magnifying glass includes a outer frame and a lens, the outer frame is detachably connected to the housing, the lens is connected to the outer frame, the lens has a virtual optical axis passing through a center of the lens, the light head has a light-emitting portion capable of emitting light at an end opposite to the housing, the light head is pivotally mounted to the housing, and when the light head rotates relative to the housing, the light-emitting portion faces towards the optical axis or in a direction parallel to the optical axis.

3. The magnifying glass and lighting tool assembly according to claim 2, wherein the housing has two first pivot ears at the end opposite to the connection part, wherein the light head has a second pivot ear at an end adjacent to the housing, wherein the second pivot ear is pivotally mounted between the two first pivot ears, wherein one of the two first pivot ears has a recess on a side opposite to the second pivot ear, wherein the outer frame has two engaging ears that respectively engage with the two first pivot ears on a side opposite to the second pivot ear, and wherein one of the two engaging ears has a protrusion on a side adjacent to the second pivot ear, the protrusion engaging with the recess.

4. The magnifying glass and lighting tool assembly according to claim 3, wherein the second pivot ear has a toothed portion on an outer periphery thereof, the housing has a catch tooth at the end opposite to the connection part, and the catch tooth is elastically deformable and maintains engagement with the toothed portion.

5. The magnifying glass and lighting tool assembly according to claim 1, wherein the support frame includes a base and a tube member, the tube member has flexibility and is bendable into any shape, one end of the tube member is connected to the base, and the connection part is provided at an end of the tube member opposite to the base.

6. The magnifying glass and lighting tool assembly according to claim 5, wherein the base has a groove at an end opposite to the tube member and is connected to a magnetic member, and wherein the magnetic member is disposed within the groove.

7. The magnifying glass and lighting tool assembly according to claim 1, wherein the connection part has a polygonal shape, the housing has an insertion hole at one end, the insertion hole has a corresponding polygonal shape, and the connection part is detachably insertable into the insertion hole.

8. The magnifying glass and lighting tool assembly according to claim 7, wherein the connection part has a receiving groove on an outer periphery thereof, the receiving groove contains a locking member and an elastic member, one end of the elastic member abuts against a bottom surface of the receiving groove and another end abuts against the locking member, the insertion hole has a plurality of locking grooves on an inner periphery thereof, and the locking member engages with one of the plurality of locking grooves.

9. An illumination tool assembly, comprising: a support frame having a connection part; and an illumination device including a housing and a light head, wherein one end of the housing is detachably connectable to the connection part, and the light head is rotatably connected to an end of the housing opposite to the connection part.

10. A magnifying glass and lighting tool assembly, comprising: an illumination device including a housing and a light head, wherein the light head is connected to the housing; and a magnifying glass including a outer frame and an lens, and wherein the outer frame is detachably connectable to an end of the housing, and the light head is rotatably connected to the end of the housing.

11. The magnifying glass and lighting tool assembly according to claim 1, wherein the light head is pivotally mounted to the housing, wherein the magnifying glass has a lens an optical axis, and wherein the light head is rotatable to selectively direct illumination towards or parallel to the optical axis of the magnifying glass.

12. The magnifying glass and lighting tool assembly according to claim 1, wherein the light head is pivotally mounted to the housing, wherein the magnifying glass has a lens with an optical axis, and wherein the light head is rotatable to selectively direct illumination towards or parallel to the optical axis of the magnifying glass.

13. The magnifying glass and lighting tool assembly according to claim 10, wherein the light head is pivotally mounted to the housing, wherein the magnifying glass has a lens with an optical axis, and wherein the light head is rotatable to selectively direct illumination towards or parallel to the optical axis of the magnifying glass.
